(19) United States
(12) Patent Application Publication
(10) Pub. No.: US 2026/0064935 A1
(43) Pub. Date: Mar. 5, 2026

(54) SYSTEMS AND METHODS FOR GENERATING REPORTS FROM MODIFIED PRINTABLE DASHBOARDS

(71) Applicant: Honeywell International Inc., Charlotte, NC (US)

(72) Inventors: Shailesh Rasane, Roseville (AU); Scott Kemp, Glenfield (AU); Boon Toh, Toorak Gardens (AU); Tommy Tanzil, Bardia (AU)

(21) Appl. No.: 18/825,678

(22) Filed: Sep. 5, 2024

(51) Int. Cl. G06F 40/114; G06F 40/106; G06F 40/166; G06T 11/00

(52) U.S. Cl. CPC G06F 40/114; G06F 40/106; G06F 40/166; G06T 11/10

(57) ABSTRACT

An example method for generating reports from modified dashboards includes displaying graphical information via a customized dashboard, where the displayed information corresponds to information associated with one or more user-customizable widgets; receiving a request to generate a report including at least some of the graphical information displayed via the customized dashboard; responsive to receiving the request to generate the report, cloning the customized dashboard to form a cloned dashboard; and automatically modifying the cloned dashboard to form a modified dashboard with information, a size, a color, or any combination thereof, that is different than but is representative of at least some of the graphical information displayed via the customized dashboard; and generating a report including a graphical representation of the modified dashboard.

### TECHNICAL FIELD

The present disclosure relates systems, devices, and methods for generating reports from modified printable dashboards.

### BACKGROUND

A dashboard is a visual interface that displays key information, metrics, and data in a concise and easily understandable format. Dashboards can aggregate data from various sources and present it through charts, graphs, tables, and other visual elements, allowing users to monitor performance, track trends, and make informed decisions quickly. Dashboards may be employed in business, finance, marketing, and various industrial processes and/or industrial process control and automation system, among other industries, to monitor performance, track trends, and/or make informed decisions, etc.

Some dashboards may be customizable. For instance, a dashboard builder is a software tool or feature within a larger platform that allows users to create, customize, and manage dashboards. Dashboard builders offer a user-friendly e.g., drag-and-drop interface that allows users to add, arrange, and customize information (such as charts, graphs, tables, and gauges) without needing to write the underlying code to customize content in a resultant customized dashboard. For instance, some dashboard builders use a grid-based system of widgets that can fetch and visualize data in different formats like charts (column, bar), tables, free hand text, images. The user can define the widget layout and its locations/dimensions in the grid at different screen widths. i.e. on a smaller screen, the layout of widgets can be self-organizing e.g., in a vertical layout. That is, some customized dashboards created with these tools may be responsive, meaning the dashboards adjust automatically to fit or be displayed on different screen sizes, whether on a desktop, tablet, or smartphone. Additionally, some dashboard builders allow use of interactive elements, such as drill-down menus, filters, and hover-over effects, etc., for instance, that permit users to explore information in the customized dashboard.

The customizable and responsive nature of the dashboards (e.g., customizable location and/or type of widgets) can contribute to a positive end user experience (e.g., when interacting with or viewing the customized dashboard). However, due to the customizable and/or responsive nature of the dashboards, the customized information displayed via the customized dashboard may not lend itself to being readily conveyed in other formats. For instance, a user seeking to generate a report including the information in the customizable dashboard may experience difficulties or an inability to generate a report with all of the information displayed in the dashboard. That is, the resultant report may be truncated or lack at least some of the information that is present and viewable in the actual dashboard.

### SUMMARY

The present disclosure relates generally to systems and methods for generating reports from modified (e.g., printable) dashboards. As mentioned, a user seeking to generate a report including the information in the customizable dashboard may experience difficulties or an inability to generate a report with all of the information the dashboard. That is, the resultant report may be truncated or lack at least some of the information that is present and viewable in the actual dashboard. For instance, due to permitting customized locations and/or different types of widgets, the resultant information in the customized dashboard may not be uniformly sized/shaped, etc. to be readily generated as a report. For example, various information (e.g., rows in a chart, information in a drop-down menu, etc.) may be purposefully hidden at times or is “lazily loaded” and thus may require scrolling or other user interaction with dashboard to view such information, despite the information being present in the customized dashboard. The hidden information may not include in a report generated from the dashboard. For instance, the resultant report (e.g., a PDF or other electronic document) may only include information that is visible to a user in the dashboard at the time the report is generated, despite other information being present in the dashboard. Additionally, a user may select or customize a particular color scheme or theme for the customized dashboard. However, some user-selected color schemes or themes (e.g., dark mode) may not be readily printable (e.g., may not be readily reproducible in different electronic formats and/or may consume an excessive amount of ink if physically printed).

Accordingly, the present disclosure is directed to generating reports from modified dashboards, as detailed herein. Generation of the modified dashboards represents a feature that is an enhancement in addition to the typical generation and display of a customized dashboard. The modified dashboards can be generated based on the information in the customized dashboards (e.g., to include graphical representations of all graphical information displayed or hidden in the customized dashboards) without modification of the actual customized dashboards, as detailed herein. Thus, the modified dashboards can be provided as reports or otherwise utilized, while also retaining full-functionality and without impacting visualization or display of the information in the actual customized dashboards. Examples of modifications to the information displayed or graphically represented in the actual customized dashboard include pagination of the displayed graphical information in the customized dashboard, hiding various elements (e.g., confidential or sensitive information) that should be omitted from a print preview, resizing at least a portion of the displayed graphical information, altering a color scheme of the displayed graphical information to a default color scheme, altering a size, a location, or both, of the information associated with the one or more widgets, among other possible modifications, as detailed herein.

In some embodiments, the modified dashboards can be generated to include additional information that is not present in the actual customized dashboards. For instance, the modified dashboards can include additional information that is manifested as identifying information associated with the customized dashboard. For example, the identifying information can be included at least a facility identifier or an identifier of a portion of the facility associated with the information displayed in the customized dashboard (e.g., a building management dashboard), among other identifying information, as detailed herein. Thus, a resultant report or other document that includes or is based on the modified dashboard can readily convey to a recipient thereof a facility or other identifying information that is specific to the information in the modified dashboard.

In some embodiments, the modified dashboards can include hidden information or information that is redacted from the information that is displayed in the actual customized dashboard. For instance, a print preview including the modified dashboard, a report including the modified dashboard, or both, may have some information that is redacted (e.g., hidden or not included) relative to the information displayed in the actual customized dashboards. For instance, sensitive or confidential information and/or information that is irrelevant or duplicative (e.g., in the context of the report) may be redacted from and not displayed in the modified dashboard in a report (e.g., in an electronic report such as a PDF report). As such, the approaches herein can yield streamlined reports that can permit recipients thereof (e.g., a site supervisor, etc.) to readily ascertain pertinent information in the report and/or avoid disclosing sensitive or confidential information (e.g., various equipment settings or other process conditions) to outside individual. Hence, the system and methods herein can yield improved report generation which can result in improved functioning of various devices and individuals (e.g., site managers) associated with one or more sites, as detailed herein.

In some embodiments, the systems and methods herein permit the display of graphical user interfaces (in the form of live dashboards displaying various real-time information, as detailed herein) and generating modified reports therefrom without alteration of the actual content displayed in the actual live dashboards. Maintaining a consistency of information displayed in the customized live dashboards (e.g., without modify a type or location of content displayed in the customized live or actual dashboard) when generating a report based on the information in the live dashboard is of particular of interest in the building management context. For instance, with industrial process control and automation systems information displayed in the live dashboards can be indicative of one or more occurrences of incidents (e.g., incidents pertaining to equipment, etc.) at an industrial site. It will be appreciated that industrial process control and automation systems require maintenance and upkeep, as well as rapid and effective responses to incidents in an industrial plant (e.g., as indicated by various alarms and warnings) to maintain the industrial plant in an efficient, safe and productive environment. Various personnel such as process operators, system maintenance engineers, control engineers, field engineers, technicians may rely on real-time information display in the dashboards to make decisions and perform maintenance and/or remediation actions to ensure the industrial process control and automation systems run under normal operating conditions. As such, generating modified dashboard (e.g., without modifying the content of the information in the actual customized dashboard) can yield safer and more effective building management (e.g., more timely responses to occurrences of incidents) and thereby can improve the efficiency and operation of various components (e.g., equipment) in an industrial site managed with industrial process and control (e.g., which utilizes a building management dashboard to detect and/or respond to occurrences of incidents at the industrial site).

A particular example of the present disclosure includes an illustrative method for generating reports from modified dashboards comprising: displaying graphical information via a customized dashboard, where the displayed information corresponds to information associated with one or more user-customizable widgets; receiving a request to generate a report including at least some of the graphical information displayed via the customized dashboard; responsive to receiving the request to generate the report, cloning the customized dashboard to form a cloned dashboard; and automatically modifying the cloned dashboard to form a modified dashboard with information, a size, a color, or any combination thereof, that is different than but is representative of at least some of the graphical information displayed via the customized dashboard; and generating a report including the modified dashboard.

Another example of the present disclosure includes a computing device for generating a report from a modified dashboard comprising: a display; a memory; and a processor configured to execute executable non-transitory computer readable instructions stored in the memory to: display, via the display, graphical information via a customized dashboard, wherein the displayed information corresponds to information associated with one or more user-customizable widgets; receive a request to generate a report including at least some of the graphical information displayed via the customized dashboard; responsive to receiving the request to generate the report, clone the customized dashboard to form a cloned dashboard; and automatically modify the cloned dashboard to form a modified dashboard with information, a size, a color, or any combination thereof, that is different than but is representative of at least some of the graphical information displayed via the customized dashboard; and generate a report including a graphical representation of the modified dashboard.

Another example of the present disclosure includes a non-transitory, computer-readable medium including instructions that when executed by a processor cause the processor to display, via the display, graphical information via a customized dashboard, wherein the displayed information corresponds to information associated with one or more user-customizable widgets; receive a request to generate a report including at least some of the graphical information displayed via the customized dashboard; responsive to receiving the request to generate the report, automatically clone the customized dashboard to form a cloned dashboard; and automatically modify the cloned dashboard to form a modified dashboard with information, a size, a color, or any combination thereof, that is different than but is representative of at least some of the graphical information displayed via the customized dashboard; and automatically generate a report including a graphical representation of the modified dashboard.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram of an illustrative industrial process control and automation system;

FIG. 2 is an example computing device for generating reports from modified printable dashboards;

FIG. 3 is an example of a graphical user interface of a dashboard builder for generation of a customized dashboard suitable for generating reports from modified printable dashboards;

FIG. 4 is an example of a graphical user interface of a dashboard builder for generation of a report from a customized dashboard;

FIG. 5 illustrates an example of a print preview of a report 500 including a modified dashboard 510;

FIG. 6 illustrates an example of a published report that can be accessible by one or more users;

FIG. 7 illustrates a print preview 700 of the published report; and

FIG. 8 is a flow diagram showing an illustrative method for generating reports from modified printable dashboards.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

It will be appreciated that industrial process control and automation systems require maintenance and upkeep, as well as rapid and effective responses to incidents in an industrial plant (e.g., as indicated by various alarms and warnings) to maintain the industrial plant in an efficient, safe and productive environment. Various personnel such as process operators, system maintenance engineers, control engineers, field engineers, technicians may make decisions and perform maintenance and/or remediation actions to ensure the industrial process control and automation systems run under normal operating conditions. Managing a large workforce of individuals and technicians is important for the efficient operation of industrial process, control, and automation systems within an industrial plant. Due to the development of technology, it is important for the workforce and personnel who oversee an industrial plant to continually update their skill set in order to efficiently operate new equipment and the like. Similarly, due to the occurrence of systematic incidents and/or occurrence of unforeseen incidents at a site it is desired to quantify responsiveness and/or a quantity of resolved incidents and open incidents. Thus, the use of customized dashboards may be sought, for instance, which can be tailored to facilitate normal operation and/or incident resolution at particular sites (e.g., with particular processes, equipment, and buildings).

Accordingly, various embodiments of the present disclosure provide for a unified interest layer (referred to herein as a “dashboard”) allowing at-a-glance views of various aspects (e.g., performance indicators, statistics, analytics, and/or metrics) associated with an operational (e.g., working) system. Systems, as used herein, can refer to various systems including, for example, fire safety systems, heating, ventilation, and air conditioning (HVAC) systems, security systems, access control systems, and/or energy management systems, among other types of systems. In a general sense, dashboards of the present disclosure can display data associated with the various aspects of such systems (herein referred to as “information” in and/or as summaries, trends, comparisons, and/or exceptions, among other ways of displaying information.

Embodiments of the present disclosure can receive (e.g., gather) data from a number of systems and display information in various displays (e.g., dashboards) which can be determined based on an identity and/or role of a user, for instance. Embodiments of the present disclosure can display a dashboard on various user devices including, by way of example and not limitation, desktop computers, laptop computers, tablets, smart phones, and/or personal digital assistants (PDAs), for instance. Further, embodiments of the present disclosure can display dashboards on various computing and/or device platforms (e.g., operating systems).

Accordingly, embodiments of the present disclosure can provide various users (e.g., operators, managers, chief security officers (CSOs), etc.) easily viewable and easily understandable information associated with the various systems described herein. Such users can use the provided information to make more informed and/or higher-level decisions than by using previous approaches. For example, managers can use such information to make decisions regarding contracts, purchases, site operation, and/or personnel management, among other decisions.

Dashboards in accordance with one or more embodiments of the present disclosure can include a number of display elements, sometimes referred to herein as “widgets.” Widgets in accordance with embodiments of the present disclosure can include software accessories for providing (e.g., displaying) various information associated with various aspects of systems such as those previously discussed.

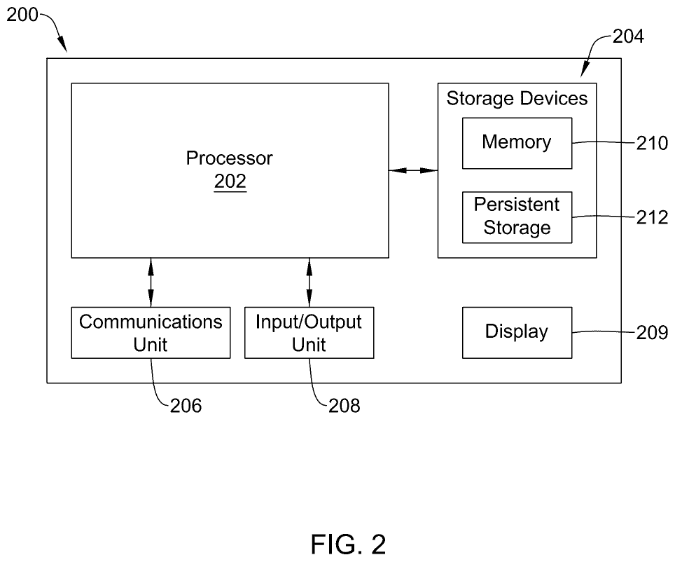

Widgets can interact with remote sources of information, such as servers or other computing devices (e.g., computing device 200 discussed below in connection with FIG. 2), to provide information. Widgets can be used to access various pages (e.g., html webpages). Widgets can be interactive, so that a user performs common input operations (e.g., clicking a mouse, typing on a keyboard, touching a screen) to utilize the functionality of a widget.

Dashboards (e.g., widgets of a dashboard) in accordance with one or more embodiments of the present disclosure can be user-configurable. A user can interact with and/or configure widgets as desired, for instance. In various embodiments, some widgets may be resizable, and some may be of fixed size. In some embodiments, a user can move widgets around the display, and/or can resize widgets if applicable. Some widgets can automatically resize themselves based on the amount or nature of the information being displayed. Various embodiments allow a user to manipulate, adjust, and/or otherwise personalize particular information included in dashboards and/or widgets in accordance with the present disclosure. Personalization of displayed information may be determined and/or limited by a user's role (e.g., identity). For example, a high-level user (e.g., a CSO) may desire higher-level summarized information (e.g., summarized monthly). Higher-level information can include, for example, monthly spending associated with a security system. A lower-level user (e.g., a team manager) may desire lower-level information (e.g., current and/or real-time information). Lower-level information can include, for example, current locations of employees and/or access devices (e.g., cards). Hence, display of information to a particular user can therefore be determined based on a role of the user. The role can be determined based upon user input of credentials and/or authentication information (e.g., log in).

However, as previously mentioned at least due to permitting customized locations and/or different types of widgets in the user-customizable dashboards, the resultant information in the customized dashboard may not be sized/shaped, etc. to be readily generated as a report. Moreover, as mentioned the information in the customized dashboards may include various information (e.g., sensitive or confidential information, etc.) that does not lend itself to inclusion in a particular report. Additionally, the information in the customized dashboards may correspond to information from various time periods and/or different sites that may not be readily identifiable to other users (different than a user that operates or created the customized dashboard).

As such, the systems and methods herein permit generating reports from modified dashboards, as detailed herein. Thus, the systems and methods herein can yield improved functioning of various devices and individuals (e.g., operators) associated with one or more sites, as detailed herein. For instance, the systems and methods herein permit the creation and display of live customized dashboards displaying various real-time information, as detailed herein. The customized dashboards can facilitate the operation, management and/or control of a site. Yet, the systems and methods, as detailed herein, also permit generation of reports (e.g., electronic reports such as PDFs) including modified dashboards which are based on or include all information in the live customized dashboards without modifying or impacting the live customized dashboard. The reports can lend themselves to an additional degree of management and/or control of the site, and hence can improve the efficiency and operation of various components (e.g., equipment) in the site such as an industrial site. While various figures herein pertain to industrial processes and industrial process and automation systems, it is understood that the system and methods herein are applicable to other types of sites.

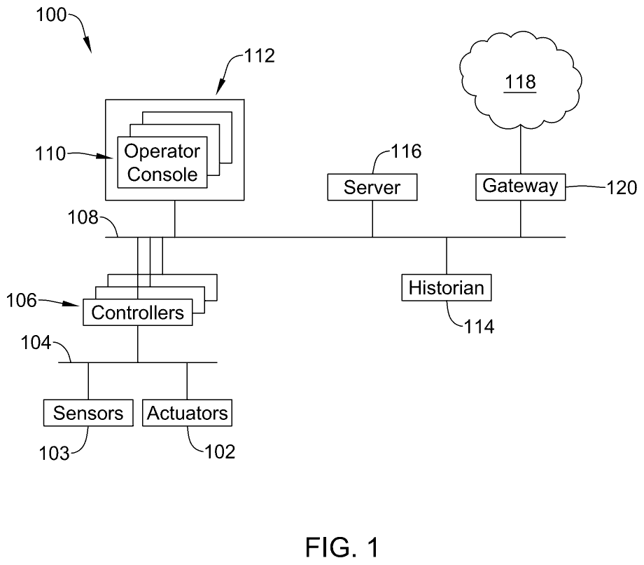

FIG. 1 provides a schematic block diagram showing an illustrative industrial process control and automation system 100. The system 100 includes various components that facilitate production or processing of at least one product or other material. For instance, the system 100 can be used to facilitate control over components in one or multiple industrial plants. The industrial plants may be one or more processing facilities (or one or more portions thereof), such as one or more manufacturing facilities for producing at least one product or other material. In general, the industrial plants may implement one or more industrial processes and can individually or collectively be referred to as a process system. A process system generally represents any system or portion thereof configured to process one or more products or other materials in some manner.

The system 100 includes one or more sensors 103 and one or more actuators 102. The sensors 103 and the actuators 102 represent components in a process system that may perform any of a wide variety of functions. In certain embodiments, sensors 103 and actuators 102 can correspond to equipment that is controlled by the automation system. That is, the sensors 103 and actuators 102 represent components in the industrial plant that perform any of a wide variety of functions. For example, sensors and actuators can measure various characteristics of the process system as well as alter any number of characteristics in the process system of the industrial plant represented by the system 100. The sensors 103 and actuators 102 can be automatically controlled by the process system of the industrial plant, manually controlled, or a combination thereof. The control and manipulation of the sensors 103 by the personnel or the process system of the industrial plant, or the combination thereof can be recorded by the historian, discussed in further detail below. For example, each time the sensors 103 and actuators 102 are adjusted, a record is created within the historian. The sensors 103 may measure a wide variety of characteristics in the process system, such as but not limited to temperature, pressure, flow rate, chemical concentrations, or a voltage transmitted through an electrical conductor. The actuators 102 may represent devices that are configured to alter a wide variety of characteristics in the process system. As an example, the actuators 102 may open or close one or more valves, or increase or decrease a process set point or the like. At any rate, each sensor 103 may include any suitable structure for measuring one or more characteristics in a process system. Each actuator 102 may include any suitable structure for operating on or affecting one or more conditions of a process system.

In the example shown, a network 104 is coupled to the sensors 103 and the actuators 102. The network 104 facilitates interaction with the sensors 103 and the actuator 102. For example, the network 104 may transmit measurement data from the sensors 103 and/or may provide control signals to the actuator 102. The network 104 may represent any suitable network or combination of networks. As particular examples, the network 104 could represent at least one Ethernet network (such as one supporting a FOUNDATION FIELDBUS protocol), electrical signal network (such as a HART network), Ethernet network, pneumatic control signal network, or any other or additional type(s) of network(s), or any other type of communication path.

The illustrative system 100 also includes various controllers 106. The controllers 106 may, for example, be used in the system 100 to perform various functions in order to control one or more industrial processes. To illustrate, a first set of controllers 106 may use measurements from one or more of the sensors 103 to control the operation of one or more of the actuators 102. A controller 18 may receive measurement data from one or more sensors 103 and use the measurement data to generate control signals for one or more actuators 102. A second set of controllers 106 may be used to optimize the control logic or other operations performed by the first set of controllers. A third set of controllers 106 could be used to perform additional functions. The controllers 106 could therefore support a combination of approaches, such as regulatory control, advanced regulatory control, supervisory control, and advanced process control.

Each of the controllers 106 may include any suitable structure for controlling one or more aspects of an industrial process. At least some of the controllers 106 may, for example, represent proportional-integral-derivative (PID) controllers or multivariable controllers, such as controllers implementing model predictive control (MPC) or other advanced predictive control (APC). As a particular example, each controller of the controllers 106 may represent a computing device running a real-time operating system, a WINDOWS operating system, or other operating system.

In the illustrative system 100, at least one network 108 couples to the controllers 106 and the other devices in the system 100. The network 108 facilitates communication of information between components. The network 108 may represent any suitable network or combination of networks. For example, the network 108 could represent an Ethernet network or any other suitable communication path.

Operator access to and interaction with the controllers 106 and other components of the system 100 can occur via various operator consoles 110. Each operator console 110 may be used to provide information to an operator and receive information from an operator. For example, each operator console 110 may provide information identifying a current state of an industrial process to the operator, such as values of various process variables and warnings, alarms, or other states associated with the industrial process. Each operator console of the operator consoles 110 may also receive information affecting how the industrial process is controlled, such as by receiving set points or control modes for process variables controlled by the controllers 106 or other information that alters or affects how the controllers 106 control the industrial process. Each operator console 110 may include any suitable structure for displaying information to and interacting with an operator. For example, each operator console 110 may represent a computing device running a WINDOWS operating system or other operating system. In some embodiments, the operator console 110 can be configured to display the customized dashboards described herein. Alternatively or additionally, the customized dashboards (e.g., described herein can be displayed elsewhere, for instance, at a console associated with a supervisor or other personnel associated with the industrial plant.

Multiple operator consoles 110 may be grouped together and used in one or more control rooms 112. Each control room 112 may include any number of operator consoles 110 in any suitable arrangement. In some cases, multiple control rooms 112 may be used to control an industrial plant, such as when each control room 112 contains operator consoles 110 used to manage a discrete part of the industrial process/plant.

The illustrative system 100 also includes one or more servers 116. Each server 116 denotes a computing device that executes applications for users of the operator consoles 110 or other applications. The applications could be used to support various functions for the operator consoles 110, the controllers 106, or other components of the system 100. The servers 116 may be located locally or remotely from the illustrative system 100. For instance, the functionality of the server 116 could be implemented in a computing cloud or a remote server communicatively coupled to the system 100 via a gateway such as gateway 120. Each server 116 may represent a computing device running a WINDOWS operating system or other operating system. Note that while shown as being local within the system 100, the functionality of the server 116 may be remote from the system 100. For instance, the functionality of the server 116 may be implemented in a cloud-based server 118 or a remote server communicatively coupled to the system 100 via the gateway 120.

The control and automation system 100 here also includes at least one historian 114. The historian 114 represents a component that stores various information about the system 100. The historian 114 could, for instance, store information that is generated by the various controllers and/or various operators, etc. during the control of one or more industrial processes. The historian 114 includes any suitable structure for storing and facilitating retrieval of information such as a volatile and/or non-volatile memory. Although shown as a single component here, the historian 114 could be located elsewhere in the system 100, or multiple historians could be distributed in different locations in the system 100.

Although FIG. 1 shows one example of the industrial process control and automation system 100, it will be appreciated that various changes may be made. For example, the control and automation system 100 may include any number of sensors, actuators, controllers, servers, networks, operator stations, operator consoles, control rooms, networks, and other components. Also, the makeup and arrangement of the system 100 in FIG. 1 is for illustration only. Components may be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment of an industrial plant where system operations done by the various personnel can be monitored. This functionality can be used in any other suitable system, and that system need not be used for industrial process control and automation.

FIG. 2 illustrates an example computing device for generating reports from modified dashboards. In particular, FIG. 2 illustrates an example computing device 200. In some embodiments, the computing device 200 could denote an operator station, server, a remote server or device, or a mobile device. The computing device 200 could be used to run applications. The computing device 200 could be used to perform one or more functions, such as collecting information, sorting and analyzing the information via a dashboard (e.g., a customized dashboard), generating a modified dashboards, as well as generating a report including the modified dashboard, etc. For ease of explanation, and the computing device 200 are described as being used in the system 100 of FIG. 1, although the computing device 200 could be used in any other suitable system (whether or not related to industrial process control and automation).

As shown in FIG. 2, the computing device 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) configured to store and facilitate retrieval of information (such as data, program code, and/or other suitable information on a temporary or permanent basis). The memory 210 may represent a random-access memory or any other suitable volatile or non-volatile storage device(s). The persistent storage 212 may contain one or more components or devices supporting longer-term storage of data, such as a read-only memory, hard drive, flash memory, or optical disc.

The communications unit 206 supports communications with other systems or devices. For example, the communications unit 206 could include at least one network interface card or wireless transceiver facilitating communications over at least one wired or wireless network (such as a local intranet or a public network like the Internet). The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display such as a display 209, printer, or other suitable output device.

The display 209 allows at least output of data such as display of a dashboard (e.g., a customized dashboard), a print preview of report including a modified dashboard, and/or a report including a modified dashboard. In some instances, the display 209 corresponds to a monitor. In some embodiments, the display 209 corresponds to a touch screen display that allows input and output of data.

Although FIG. 2 illustrates an example computing device 200 capable of facilitating or otherwise performing at least some aspects of generating reports from modified dashboards may be made to FIG. 2. For example, various components in FIG. 2 could be combined, further subdivided, or omitted, and additional components could be added according to particular needs. As a particular example, processor 202 can be divided into multiple processors (e.g., hardware processors), such as one or more central processing units (CPUs) and one or more graphics processing units (GPUs). Also, computing device 200 can come in a wide variety of configurations, and FIG. 2 does not limit this disclosure to any particular computing device or mobile device.

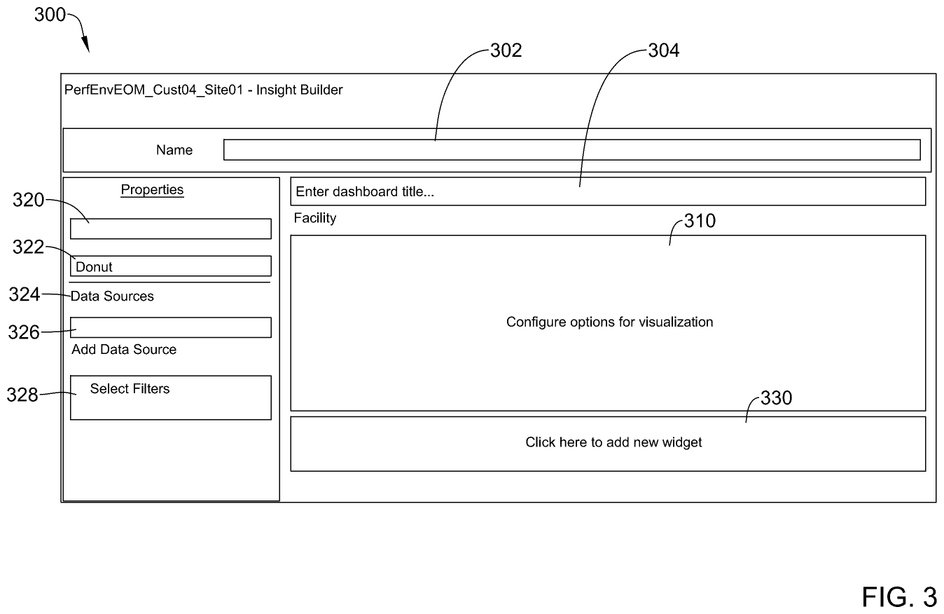

FIG. 3 is an example of a graphical user interface 300 of a dashboard builder for generation of a customized dashboard. The graphical user interface 300 can be included in or displayed by a computing device such as the computing device 200, as described herein with respect to FIG. 2. The information displayed in the graphical user interface 300 can correspond to or be based on information associated with one or more dashboard builders or other type of application. An example of a suitable dashboard builder is INSIGHT™; available from HONEYWELL INTERNATIONAL, INC. This is only an example and various other suitable dashboard builders may be employed to perform some or all aspects herein. That is the graphical user interface 300 of the dashboard builder can come in a wide variety of configurations, and FIG. 3 does not limit this disclosure to any particular computing device or mobile device.

The time period and/or the one of more sites can be selectable. For instance, both the time period and the one or more sites can be selectable via a dropdown menu which corresponds to one or more selectable sites and a dropdown menu which corresponds to a selectable time period) or can otherwise be selected (e.g., by a site supervisor). Thus, the information displayed via the graphical user interface 300 can be tailored to a particular time period (e.g., a day, a week, a month, a year, all time, etc.) and one or more sites (e.g., an individual site, a collection of some but not all sites, or all sites, etc.). For example, as illustrated in FIG. 3 the information generated for display in the graphical user interface 300 corresponds to information for a particular customer 04 and site 01 associated with the particular customer, as indicated by “Cust_04Site_01” in FIG. 3. Similarly, as illustrated in FIG. 3 the information generated for display in the graphical user interface 300 can correspond to information for a particular time period (e.g., Jul. 31, 2024 to Aug. 7, 2024, etc.).

At 302, the graphical user interface 300 can permit the dashboard name of the customized dashboard to be input. Similarly, at 304 a title of the resultant customized dashboard can be entered. The graphical interface 300 can permit the information in the resultant customized dashboard to be tailored to a specific site (e.g., facility), region, and/or portfolio, etc. For instance, various options (e.g., site, region, portfolio, etc.) can permit the corresponding information to be displayed as a customized dashboard, as illustrated at 310.

As mentioned, some dashboard builders offer a user-friendly, drag-and-drop interface that allows users to add, arrange, and customize widgets (such as charts, graphs, tables, and gauges) without needing to write code to customize the content within a resultant dashboard. For instance, at 320 a widget label can be input or selected. At 322, a particular widget (e.g., from a plurality of preexisting widgets) can be selected. For instance, at 322 one or more widgets can be selected from a drop-down menu including a plurality of preexisting widgets. At 324, a data source (e.g., for the data corresponding to the one or more selected widgets) can be selected. The data source can correspond to a particular site, region, customer, etc. For instance, the data source can correspond to one or more data sources (e.g., “Asset telemetry”) selected from a plurality of data sources in a drop-down menu, as indicated at 326. One or more data sources can be selected for each of the one or more widgets selected. In some embodiments, one or more filters can be selected at 328 to filter the data from the one or more data sources. At 330, additional widgets can be added, for instance such that the resultant customized dashboard can include any quantity and/or type of user-selected widget(s).

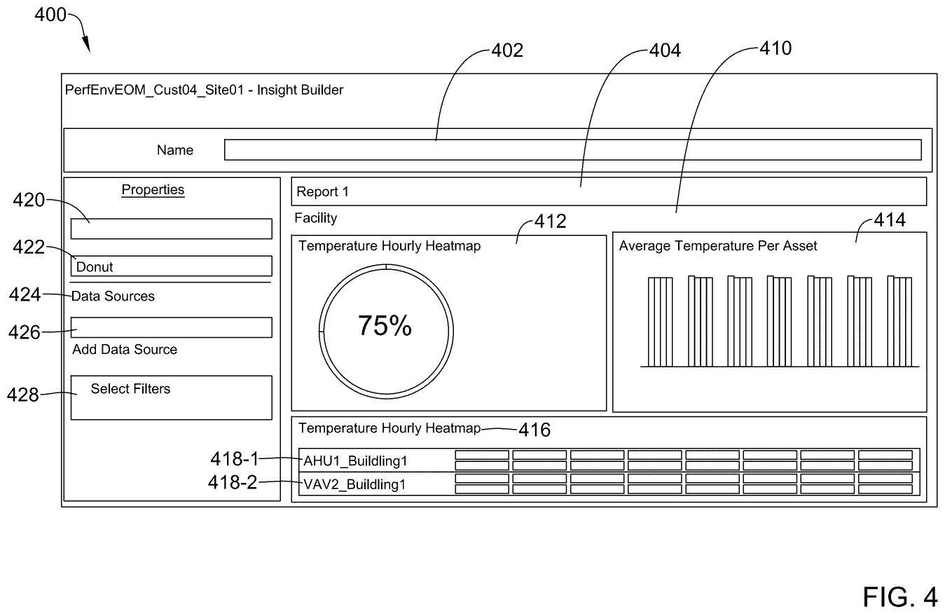

FIG. 4 is another example of a graphical user interface 400 of a dashboard builder for generation of a report from a customized dashboard (e.g., as named at 402). As mentioned, the graphical user interface 400, and hence the customized dashboard 410, can display a plurality of visual (e.g., graphical) representations. The visual representations can include visual representations of various information pertaining to one or more client sites in the building automation and control context. For instance, as illustrated in FIG. 4, the information displayed can correspond to information (e.g., real-time information) associated with a plurality of user-selected widgets 412 (e.g., temperature and hourly heatmap widget), 414 (e.g., average temperature per asset widget), and 416 (temperature and hourly heatmap widget). For example, a temperature and hourly heatmap widget can be selected at 420. A widget type (e.g., donut) can be selected at 422. One or more data sources for the selected widget can be selected at 424. For instance, the data source (e.g., asset telemetry) can be selected from a plurality of data sources that are selectable via a dropdown menu, as indicated at 426. At 428, one or more filters (e.g., date, location, site, etc.) can be selected for the one or more data sources.

As mentioned, the customized dashboard 410 allows can be included in a report 404 to permit at-a-glance views of various aspects (e.g., performance indicators, statistics, analytics, and/or metrics) associated with an operational (e.g., working) system, for example, fire safety systems, heating, ventilation, and air conditioning (HVAC) systems, security systems, access control systems, and/or energy management systems, among other types of systems. The information can be displayed as tables, charts, various diagrams, etc. to readily convey the information in and/or as summaries, trends, comparisons, and/or exceptions, among other ways of displaying information.

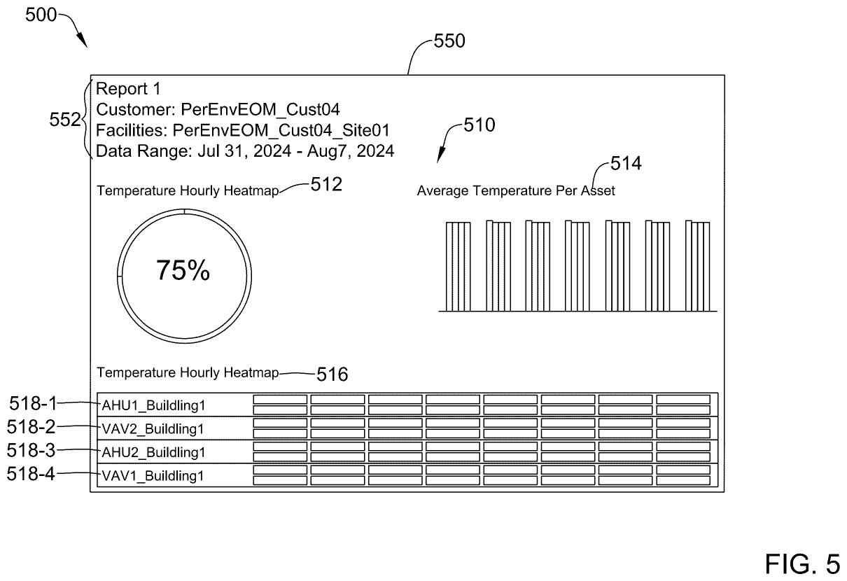

As illustrated in FIG. 4, visual representation of the information of each of the user-selected widgets 412, 414, 416, can be collectively displayed as at least a portion of a customized dashboard 410. However, as illustrated in FIG. 4, a portion of the information in the resultant customized dashboard 410 may not be visible (e.g., based on the size and/or resolution of the graphical user interface 400). Stated differently, a subset of the information (e.g., some or all of the graphical representations corresponding to information of the widgets) in the customized dashboard 410 may not be visible from the perspective of a user of the customized dashboard 410 at a given time. As a specific example, while the customized dashboard 410 is illustrated as including and displaying rows 418-1 and 418-2 of a data table in widget 416, it is noted that the data table includes additional information (e.g., rows 518-3 and 518-4, as illustrated in FIG. 5) that are not visible to a user of the customized dashboard 410. To view the additional information (e.g., rows 518-3 and 518-4) a user of the customized dashboard 410 can simply interact with (e.g., scroll, resize, etc.) the dashboard 410 etc. That is, the user can interact with the dashboard 410 to view or otherwise access such information in the dashboard 410.

Yet, as mentioned, such information (e.g., that is not visible to a user of the dashboard 410 depending on the particular subset of the information that is displayed in the dashboard 410) e.g., due at least in part to the customizable and/or responsive nature of the dashboards, may not lend itself to being readily conveyed in other formats. For instance, a user seeking to generate a report including the information (e.g., all rows in the data table of the widget 416) in the customizable dashboard 410 may experience difficulties or an inability to generate a report with all of the information in the customized dashboard 410. That is, the resultant report may be truncated or lack at least some of the information (e.g., rows 518-3 and 518-4) that is present in the customized dashboard 410 but is not visible at a given point in time to a user of the customized dashboard 410.

Thus, the approaches herein permit generation of modified dashboards. The modified dashboards can a size (e.g., a different resolution, different font size, etc.), a color, or any combination thereof, that is different than but is representative of at least some of the graphical information displayed via a customized dashboard such as the customized dashboards. For example, the modified dashboards can lend themselves to readily conveying all information in a customized dashboard in a different format (e.g., as an electronic or physical report), among other benefits described herein. For example, a modified dashboard can, in some instances, be generated responsive to receipt of a request to print or otherwise convey the information in a customized dashboard such as the customized dashboard 410. That is, the modified dashboards can be generated responsive to an input (e.g., a user selection of a print icon) displayed in a graphical user interface and/or a customized dashboard. For instance, in some embodiments the modified dashboards can be generated automatically (e.g., responsive to a user input but in the absence of any subsequent user inputs), for instance, by a computing device (e.g., computing device 200). Thus, the modified dashboards can be timely and consistently generated.

In some embodiments, the modified dashboard can be generated from a cloned dashboard. That is, a customized dashboard such as the customized dashboard 410 can be cloned to form a clone dashboard. The cloned dashboard can be a mirror copy (e.g., including all information in the same format (e.g., widgets displayed at the same location, text in the same color) etc. as the information in the customized dashboard. In some embodiments, the cloned dashboard can include each of the same widgets, each of the same data sources, etc. as the customized dashboard. For example, a computing device such as the computing device 200 herein can create and store a cloned dashboard that is representative of or identical to a customized dashboard. For instance, the graphical user interfaces, the dashboard builders, and/or the customized dashboards herein can include a selectable icon such as a “Clone,” “Duplicate,” “Copy,” or “Save” icon that is selectable to automatically cause a customized dashboard to be cloned (e.g., automatically cause a cloned dashboard to be generated). As an example, cloning of the customized dashboard can employ a library or other type of storage element to copy the various elements in the customized dashboard (e.g., html elements) and styles, for instance, to a hidden part of the HTML document in an iframe or other similar type of inline frame (e.g., which allows another HTML document or element to be embedded within the current webpage) and can reference or call a native browser (e.g., window.print) to show cloned dashboard and/or the web browsers print preview of the cloned dashboard. Such cloning allows isolation of any additional styling changes to that cloned part of the dashboard.

Thus, after cloning, the resultant cloned dashboard can be modified without affecting performance of (e.g., real-time display of information) or altering the content in the customized (e.g., original) dashboard. For instance, in various embodiments that systems and methods herein can automatically modifying the cloned dashboard to form a modified dashboard with information, a size, a color, or any combination thereof, that is different than but is representative of at least some of the graphical information displayed via the dashboard.

In some embodiments, a computing device such as the computing device 200 can automatically modify the cloned dashboard, for instance, in the absence of displayed of the cloned dashboard. For example, the computing device can store a default size, default resolution, default color or color scheme (e.g., black and white or grayscale, etc.), and/or a default layout (e.g., of various widgets and/or layouts of information associated with one or more widgets and/or data sources), along with various other default configurations. The default configurations can be customized by a site supervisor or other individual. The default configurations can be stored in the computing device 200 or can be otherwise stored and accessible by (e.g., computing device 200. Thus, the computing device 200 herein can automatically modify a cloned dashboard, as described herein, to form a modified dashboard.

Examples of modifications to the cloned dashboard (e.g., to information displayed or graphically represented in the actual customized dashboard) include pagination of the displayed graphical information in the actual customized dashboard, hiding various elements (e.g., confidential or sensitive information) that should be omitted from a print preview, resizing at least a portion of the displayed graphical information, altering a color scheme of the displayed graphical information to a default color scheme, altering a size, a location, or both, of the information associated with the one or more widgets, among other possible modification as detailed herein.

In some embodiments, the modification includes altering a size, a location, or both, of the information associated with the one or more widgets. For instance, the modification can modify the size, location, or both, of the information (e.g., rows in a table) with the one or more widgets to ensure that all of the information associated with the widgets in the customized dashboard is included in and visible in any subsequent report generated that includes or is based on the modified dashboard. In some embodiments, the modification can include adding non-displayed content information associated with the one or more widgets that is not included in the displayed graphical information to the cloned dashboard, and hence to the subsequent modified dashboard and a report generated therefrom. For example, a table including a plurality of rows corresponding to information of a user-selected widget in the customized dashboard can be expanded so that each of the plurality of rows is visible (e.g., at the same time) in the subsequent report.

In some embodiments, the modification (e.g., modifying the displayed graphical information in the cloned dashboard) includes pagination of the displayed graphical information. Pagination can case generating a report including the displayed graphical information.

In some embodiments, the modification includes hiding a portion of the displayed graphical information as hidden information. For instance, the hidden portion may not be included in (e.g., is entirely redacted or at least is not visible to from a user perspective) in a print preview of the modified dashboard, is not included in the report including the modified dashboard, or both. As mentioned, examples of information that may be hidden includes any sensitive (e.g., personal) or confidential information, among other types of information.

In some embodiments, the modification includes at least resizing some or all of the graphical representations of the information in the customized dashboard such that all information in the customized dashboard is visible (e.g., on one or more pages) in modified dashboard. Thus, the resultant output (e.g., an electronic report such as a PDF) can readily convey all information in the customized dashboard to another individual e.g., an individual viewing the report but not the customized dashboard itself. In some embodiments, the modification includes one or more of pagination of the displayed graphical information, adding identifying information, and resizing the displayed information to form so that all information in the customized dashboard is visible (e.g., on one or more pages) in modified dashboard. For instance, the resultant output (e.g., an electronic report such as a PDF) can be paginated, include additional identifying (e.g., identifying a site, a customer, a time period, etc.) corresponding to the information in the customized display, and resizing some or all of the graphical representations of the information in the customized dashboard such that all information in the customized dashboard is visible (e.g., on one or more pages) in modified dashboard.

In some embodiments, the modification includes altering a color scheme of the displayed graphical information to a default color scheme. For instance, a color scheme can be modified from a full color scheme to default color scheme having white background and colored text. Thus, a dark or black colored background can be modified to a white background and any text or graphical representations (e.g., charts, etc.) can be modified to colored (e.g., gray or black text). Such modification can improve visualization of the information in the subsequent report and/or reduce any amount of ink to print the subsequent report (in embodiments where the report is an electronic report that is printable). For example, the default color scheme can be a black and white color scheme or a grayscale color scheme employed in conjunction with a white background.

In some embodiments, the system and methods herein can generate a report including or based on the modified dashboard. The report can be an electronic report such as an electronic report generating, via an electronic print driver and/or can be a physical report generated via a physical printing device (e.g., a laser printer, an inkjet printer, etc.)

In some embodiments, a print preview of a report including the modified dashboard can be displayed. For instance, FIG. 5 illustrates an example of a print preview of a report 500 including a modified dashboard 510. As illustrated in FIG. 5, the report 550 includes all information that is actually present (but may not necessarily be visible at a given time to a user) in the customized dashboard (e.g., the customized dashboard 410, as described with respect to FIG. 4). For instance, each of the rows 518-1, 518-2, 518-3, and 518-4 of the table corresponding to data from the widget 516 is visible in the report 550, despite the corresponding rows 518-3 and 518-4 not being visible in the customized dashboard 410 in FIG. 4. Hence all information corresponding to each of the widgets 512, 514, and 516 is included in the modified dashboard 510 of the report 550.

In some embodiments, the modification includes adding identifying information (represented at element 552) to a print preview, a report, or both. For instance, the identifying information can be added to a print preview and the same identifying information can be included in a subsequent report. The identifying information can include a location identifier, a customer identifier, and/or a time period identifier, among other possible types of identifiers. The identifiers can correspond to a site(s), a customer, and/or a time period in the customized dashboard (e.g., selected at a time of creation of the customized dashboard). For instance, as illustrated in FIG. 5 the identifying information 552 can include a location identifier, a customer identifier, and a time period identifier. In some embodiments, the additional information 552 can be displayed concurrently with concurrently with the information (e.g., in information corresponding to the widgets) the print preview of the report (e.g., of the modified dashboard in the report). Thus, a user can readily discern the proper context (e.g., a site location, a customer, and/or a time period) associated with the information pertaining the widgets.

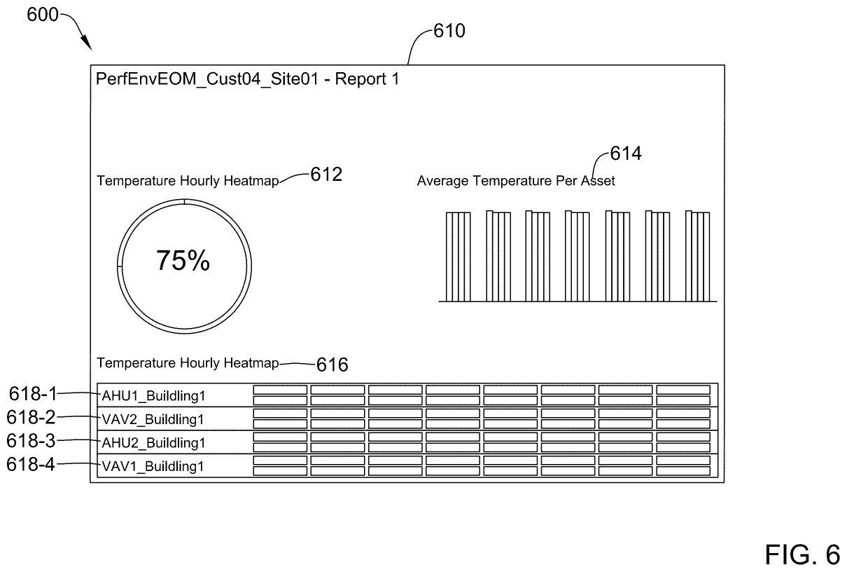

In some embodiments, the report can be published (e.g., electronically) or otherwise disseminated to a plurality of users. For instance, the report can be electronically published or made available to a plurality of users with credentials that are sufficient to permit the users to utilize the report. In some embodiments, the generated report can be automatically published to a plurality of users (e.g., to each user with sufficient credentials). The users (recipients of the published report) 50can then utilize the report and/or modify aspects of the report (e.g., customize a customer, location, and/or timer period) and obtain corresponding information for each of the widgets in the modified dashboard in the report. In some embodiments, the widgets in the published report can remain unchanged and the date (e.g., a time period) can be updated to a time period of interest (e.g., a current time period or recent time period, etc.) to permit users to readily obtain information of interest without having to modify the location and/or widgets in the modified report. As such, the approaches herein readily permit users (e.g., site managers) to utilized, and in some instances updated the information), in the report without having each of the users to generate the underlying original customized dashboard and widgets therein). Thus, the approaches herein facilitate the timely, efficient, and uniform management of various customer sites, particularly in the building automation and control context. For example, FIG. 6 illustrates an example of a published report 600 (e.g., electronically published) that can be accessible by one or more users (e.g., a site manager) with sufficient credentials. As illustrated in FIG. 6, the report 600 includes the same information (e.g., as indicated at 610, 612, 614, 616, 618-1, 618-2, 618-3, and 618-4) as the information in the report 550, as described in FIG. 5.

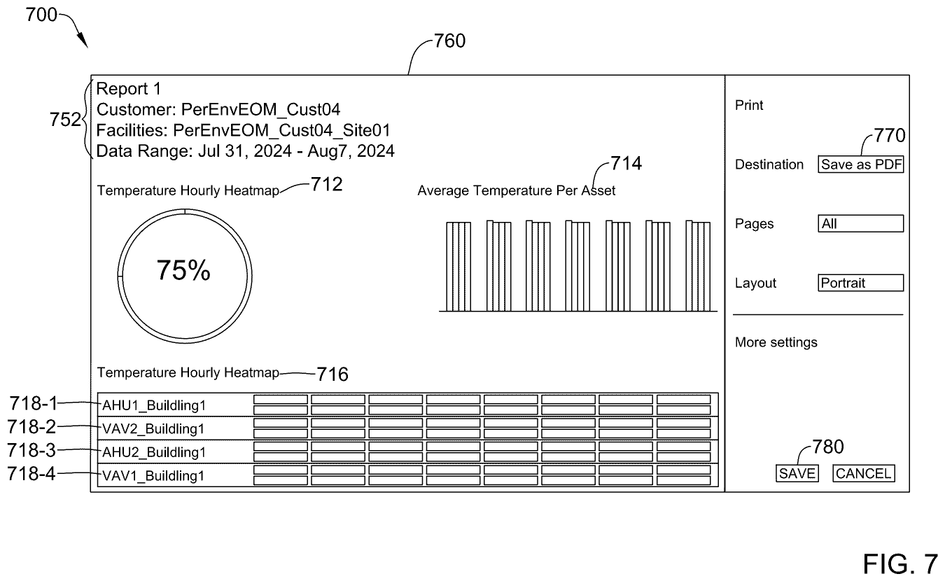

For example, the users with access to the report can print a copy (e.g., electronic copy or a physical copy) of the information in the report. FIG. 7 illustrates a print preview 700 of the published report (e.g., the published report 600 as described in FIG. 6). For instance, the print preview 700 can include the additional identifying information 752 the corresponds to the information in the published report (e.g., is representative of any user changes to the published report) and includes information (e.g., a table with rows 718-1, 718-2, 718-3 and 718-4) corresponding to the widgets 712, 714, 712 in the published report. For instance, the print preview can be printed as an electronic document such as a PDF responsive to a user selection of an icon such as the print icon 770.

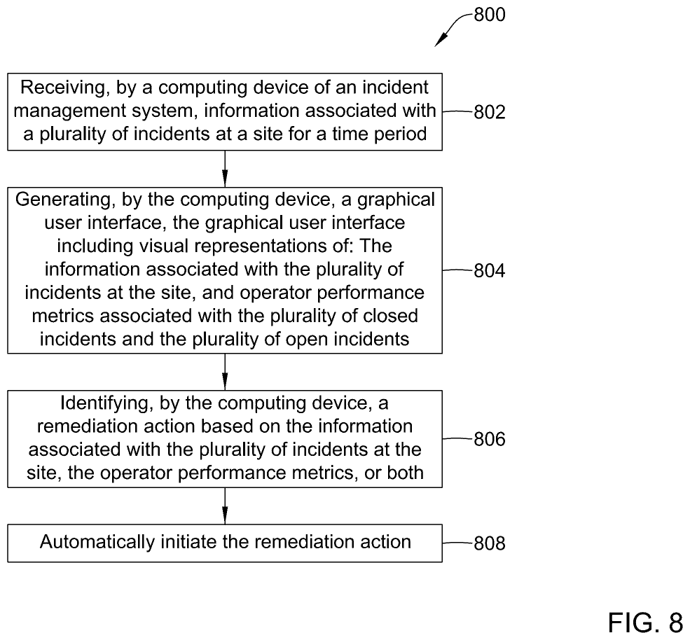

FIG. 8 is a flow diagram showing an illustrative method 800 for generating reports from modified (e.g., printable) dashboards. At 802, the method 800 includes displaying graphical information via a customized dashboard, where the displayed information corresponds to information associated with one or more user-customizable widgets, as described herein. That is, the customized dashboard can include various different widgets and corresponding information located as user-defined locations therein. At 804, the method 800 can include receiving a request to generate a report including at least some of the graphical information displayed via the customized dashboard, as described herein. For instance, a site supervisor, an operator, of other individual can request generation of a report. Responsive to receiving the request to generate the report, the method 800 can include cloning, as described herein, the customized dashboard to form a cloned dashboard; and automatically modifying, as described herein, the cloned dashboard to form a modified dashboard with information, a size, a color, or any combination thereof, that is different than but is representative of at least some of the graphical information displayed via the customized dashboard, as indicated at 806. At 808, the method 800 can include generating a report including the modified dashboard, as described herein. For instance, generating the report can include publishing the report to one or more users (e.g., one or more different users), as described herein. For example, the report can be published to a site supervisor other individual, and readily permit such individual(s) to readily review actual (real-time) information in the report, for instance, to determine when a remediation action (e.g., equipment maintenance, equipment/process set point changes, and/or changes) is needed and which particular remediation action is initiated (e.g., to ensure that the site continues to operate as intended).

Aspects of the illustrative methods herein can be performed with or via one or more of the components described herein. For instance, the illustrative methods herein can be performed in conjunction with or by at least a computing device (e.g., computing device 200), among other possible components.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for generating reports from modified dashboards, the method comprising:
displaying graphical information via a customized dashboard, wherein the displayed information corresponds to information associated with one or more user-customizable widgets;
receiving a request to generate a report including at least some of the graphical information displayed via the customized dashboard;
responsive to receiving the request to generate the report,
cloning the customized dashboard to form a cloned dashboard; and
automatically modifying the cloned dashboard to form a modified dashboard with information, a size, a color, or any combination thereof, that is different than but is representative of at least some of the graphical information displayed via the customized dashboard; and
generating a report including a graphical representation of the modified dashboard.

2. The method of claim 1, wherein the modifying the displayed graphical information further comprises pagination of the displayed graphical information.

3. The method of claim 1, wherein modifying the displayed graphical information comprises hiding a portion of the displayed graphical information as hidden information.

4. The method of claim 3, wherein the hidden portion is not included in a print preview of the modified dashboard, is not included in the report including the modified dashboard, or both.

5. The method of claim 1, wherein modifying the displayed graphical information further comprises resizing at least a portion of the displayed graphical information.

6. The method of claim 1, wherein modifying the displayed graphical information further comprises altering a color scheme of the displayed graphical information to a default color scheme.

7. The method of claim 6, wherein the default color scheme includes a white background and colored text.

8. The method of claim 1, wherein modifying the displayed graphical information further comprises altering a size, a location, or both, of the information associated with the one or more widgets.

9. The method of claim 1, wherein modifying the displayed graphical information includes adding non-displayed information associated with the one or more widgets that is not displayed in the cloned dashboard.

10. The method of claim 1, further comprising displaying a print preview of the generated report.

11. The method of claim 10, further comprising adding identifying information to the print preview, wherein the identifying information includes a location identifier, a customer identifier, a time period identifier, or any combination thereof.

12. The method of claim 1, wherein the generating the report further comprises generating, via an electronic print driver, an electronic report.

13. The method of claim 1, wherein generating the report further comprises printing, via physical printing device, a physical report.

14. A computing device for generating a report from a modified dashboard, the computing device comprising:
a display;
a memory; and
a processor configured to execute executable non-transitory computer readable instructions stored in the memory to:
display, via the display, graphical information via a customized dashboard, wherein the displayed information corresponds to information associated with one or more user-customizable widgets;
receive a request to generate a report including at least some of the graphical information displayed via the customized dashboard;
responsive to receiving the request to generate the report,
clone the customized dashboard to form a cloned dashboard; and
automatically modify the cloned dashboard to form a modified dashboard with information, a size, a color, or any combination thereof, that is different than but is representative of at least some of the graphical information displayed via the customized dashboard; and
generate a report including a graphical representation of the modified dashboard.

15. The computing device of claim 14, wherein the dashboard is a building management dashboard.

16. The computing device of claim 14, wherein the instructions are executable to automatically add additional information to the report, a print preview of the report, or both.

17. The computing device of claim 16, wherein the instructions are executable to display, via the display, a print preview of the generated report, and display the additional information concurrently with the information associated with one or more user-customizable widgets in the print preview.

18. A non-transitory, computer-readable medium including instructions that when executed by a processor cause the processor to:
display, via the display, graphical information via a customized dashboard, wherein the displayed information corresponds to information associated with one or more user-customizable widgets;
receive a request to generate a report including at least some of the graphical information displayed via the customized dashboard;
responsive to receiving the request to generate the report,
automatically clone the customized dashboard to form a cloned dashboard; and
automatically modify the cloned dashboard to form a modified dashboard with information, a size, a color, or any combination thereof, that is different than but is representative of at least some of the graphical information displayed via the customized dashboard; and
automatically generate a report including a graphical representation of the modified dashboard.

19. The medium of claim 18, wherein the instructions are executable to publish the automatically generated report to a plurality of users, wherein at least a time period of the published report is customizable by the plurality of users.

20. The medium of claim 19, wherein the published report includes a display of all of the information of the user-customized widgets in the customized dashboard.
